(19) United States
(12) Patent Application Publication
(10) Pub. No.: US 2005/0058845 A1
(43) Pub. Date: Mar. 17, 2005

(54) Multilayer structure that includes an impact-modified EVOH layer

(76) Inventors: Gaelle Bellet, Evreux (FR); Nicolas Amouroux, Valailles (FR); Thibaut Montanari, Bernay (FR); Benoit Brule, Bernay (FR); Anthony Bonnet, Beaumont le Roger (FR); Fabrice Chopinez, Evreux (FR)

Correspondence Address: Thomas F. Roland, Esq.;Atofina Chemicals, Inc., 2000 Market St., Philadelphia, PA, 19103, US

(21) Appl. No.: 10/909,505

(22) Filed: Aug. 2, 2004

Related U.S. Application Data
(60) Provisional application No. 60/523,216, filed on Nov. 19, 2003.

(30) Foreign Application Priority Data
Aug. 5, 2003 (FR) 03.09640

(51) Int. Cl. B32B 1/08

(52) U.S. Cl. 428/476.3

(57) ABSTRACT

The present invention relates to a multilayer structure comprising the following successive layers: a polyamide or HDPE (high-density polyethylene) layer; a tie layer; an impact-modified EVOH layer; optionally, a tie layer; and a polyamide or polyamide/polyolefin blend or polyolefin layer, the latter layer possibly containing fillers in order to make it antistatic; and such that the impact-modified EVOH layer is a blend based on EVOH and at least one modifier chosen from: a) functionalized ethylene/alkyl (meth)acrylate copolymers; b) products resulting from the reaction of (i) a copolymer of ethylene and of an unsaturated monomer X grafted or copolymerized with (ii) a polyamide; c) blends of a) and b); d) polyamides, preferably PA-6; e) blends of a) and d); f) elastomers, preferably EPR, EPDM and NBR, these elastomers possibly being functionalized; g) S-B-M triblocks; h) triblocks formed from a poly(butyl acrylate) block between two PMMA blocks; and i) linear or star S-B-S block copolymers, these optionally being hydrogenated (they are then denoted by S-EB-S).

This application claims benefit, under U.S.C. §119(a) of French National Application Number 03.09640, filed Aug. 5, 2003; and also claims benefit, under U.S.C. §119(e) of U.S. provisional application 60/523,216, filed Nov. 19, 2003.

### FIELD OF THE INVENTION

The present invention relates to a multilayer structure that includes an impact-modified EVOH layer. The structure may comprise the following successive layers:
a polyamide or HDPE (high-density polyethylene) layer;
a tie layer;
the impact-modified EVOH layer;
optionally, a tie layer; and
a polyamide or polyamide/polyolefin blend or polyolefin layer.

The latter polyamide or polyamide/polyolefin blend or polyolefin layer may contain fillers in order to make it antistatic.

These structures, in which the polyamide or HDPE layer is the outer layer and the polyamide or polyamide/polyolefin blend or polyolefin layer is the inner layer in contact with the fluid (petrol), are useful for making tanks, containers, bottles and tubes. They may be manufactured by coextrusion or by coextrusion blow moulding. The benefit of these structures is that they act as a barrier to many substances. One particularly beneficial use relates to tubes for transporting petrol and in particular for transporting petrol from the tank of a motor vehicle right to the engine. Another particularly beneficial use relates to petrol tanks for motor vehicles.

### BACKGROUND OF THE INVENTION

For safety and environmental protection reasons, motor vehicle manufacturers require tubes for transporting petrol to have both good mechanical properties, such as burst strength and flexibility, with good cold (−40° C.) and high-temperature (125° C.) impact strength, and also very low permeability to hydrocarbons and to their additives, particularly alcohols such as methanol and ethanol. These tubes must also have good resistance to the fuels and lubrication oils for the engine. These tubes are manufactured by coextruding the various layers using standard techniques for thermoplastics.

Among the characteristics of the specification for these tubes, five are particularly difficult to obtain jointly in a simple manner:
cold (−40° C.) impact strength—the tube must not break;
fuel resistance;
high-temperature (125° C.) strength;
very low permeability to petrol; and
good dimensional stability of the tube when used with petrol.

In multilayer tubes of various structures, the cold impact strength remains unpredictable before the standardized tests for cold impact strength have been carried out.

It has been discovered that, in a structure comprising the following successive layers:
a polyamide or HDPE (high-density polyethylene) layer;
a tie layer;
an EVOH layer;
optionally, a tie layer; and
a polyamide or polyamide/polyolefin blend or polyolefin layer,
   subjected to impacts or to other equivalent mechanical stresses, cracks are initiated in the EVOH layer and propagate into the entire structure.

It has also been discovered that, if the EVOH layer is modified by adding a sufficient amount of an impact modifier to it, then, in the event of an impact, cracks can still be initiated in this layer but there is no longer enough energy to propagate the crack or cracks into the other layers, and therefore the structure is impact-resistant.

Patent EP 1122 061 has disclosed a structure comprising, in succession:
a high-density polyethylene (HDPE) first layer;
a tie layer;
an EVOH, or EVOH-based blend, second layer; and
optionally, a polyamide (A), or polyamide (A)/polyolefin (B) blend, third layer.

Three EVOH-based blends are described in that patent. The first blend relates to compositions comprising (by weight):
55 to 99.5 parts of EVOH copolymer; and
0.5 to 45 parts of polypropylene and compatibilizer, their proportions being such that the ratio of the amount of polypropylene to the amount of compatibilizer is between 1 and 5.

The second blend relates to compositions comprising:
50 to 98% by weight of an EVOH copolymer;
1 to 50% by weight of a polyethylene; and
1 to 15% by weight of a compatibilizer formed from a blend of an LLDPE or metallocene polyethylene and of a polymer chosen from elastomers, very low-density polyethylenes and metallocene polyethylenes, the blend being cografted by an unsaturated carboxylic acid or a functional derivative of this acid.

The third blend relates to compositions comprising:
50 to 98% by weight of an EVOH copolymer;
1 to 50% by weight of an ethylene/alkyl (meth)acrylate copolymer; and
1 to 15% by weight of a compatibilizer resulting from the reaction of (i) a copolymer of ethylene and of an unsaturated monomer X grafted or copolymerized with (ii) a copolyamide.

Patents EP 1 243 831. EP 1 314 758, EP 1 314 759 and EP 1 331 091 disclose multilayer pipes which include an EVOH layer that can be formed from an EVOH-based blend identical to the blends disclosed in the abovementioned patent EP 1 122 061. These EVOH-based blends are insufficient for high impacts.

### BRIEF DESCRIPTION OF THE INVENTION

The present invention relates to a multilayer structure comprising the following successive layers:
a polyamide or HDPE (high-density polyethylene) layer;
a tie layer;
an impact-modified EVOH layer;
optionally, a tie layer; and
a polyamide or polyamide/polyolefin blend or polyolefin layer, the latter layer possibly containing fillers in order to make it antistatic;
   and such that the impact-modified EVOH layer is a blend based on EVOH and at least one impact modifier chosen from:
a) functionalized ethylene/alkyl (meth)acrylate copolymers;
b) products resulting from the reaction of (i) a copolymer of ethylene and of an unsaturated monomer X grafted or copolymerized with (ii) a polyamide;
c) blends of a) and b);
d) polyamides, preferably PA-6;
e) blends of a) and d);
f) elastomers, preferably EPR, EPDM and NBR, these elastomers possibly being functionalized;
g) S-B-M triblocks;
h) triblocks formed from a poly(butyl acrylate) block between two PMMA blocks; and
i) linear or star S-B-S block copolymers, these optionally being hydrogenated (they are then denoted by S-EB-S).

Advantageously, the proportion of impact modifier is, by weight, between 1 and 35% per 75 to 99% of EVOH respectively.

### DETAILED DESCRIPTION OF THE INVENTION

As regards a), the functional groups may be an acid, an acid anhydride or an unsaturated epoxide. The amount of unsaturated carboxylic anhydride may be up to 15% by weight of the copolymer and the amount of ethylene may be at least 50% by weight.

For example, this is a copolymer of ethylene, an alkyl (meth)acrylate and an unsaturated carboxylic anhydride. Preferably, the alkyl (meth)acrylate is such that the alkyl possesses 2 to 10 carbon atoms. The alkyl (meth)acrylate may be chosen from methyl methacrylate, ethyl acrylate, n-butyl acrylate, isobutyl acrylate and 2-ethylhexyl acrylate. The MFI may, for example, be between 0.1 and 50 (g/10 min at 190° C./2.16 kg).

For example, it is a copolymer of ethylene, an alkyl (meth)acrylate and an unsaturated epoxide. Preferably, the alkyl (meth)acrylate is such that the alkyl possesses 2 to 10 carbon atoms. The MFI (melt flow index) of (A) may, for example, be between 0.1 and 50 (g/10 min at 190° C./2.16 kg). Examples of alkyl acrylate or methacrylate that can be used are, in particular, methyl methacrylate, ethyl acrylate, n-butyl acrylate, isobutyl acrylate and 2-ethylhexyl acrylate. Examples of unsaturated epoxides that can be used are, in particular:
aliphatic glycidyl esters and ethers, such as allyl glycidyl ether, vinyl glycidyl ether, glycidyl maleate and glycidyl itaconate, glycidyl acrylate and glycidyl methacrylate; and
alicyclic glycidyl esters and ethers, such as 2-cyclohexen-1-yl glycidyl ether, diglycidyl cyclohexene-4-5-carboxylate, glycidyl cyclohexene-4-carboxylate, glycidyl 2-methyl-5-norbornene-2-carboxylate and diglycidyl endo-cis-bicyclo[2.2.1]hept-5-ene-2,3-dicarboxylate.

As regards b), this is, for example a polyamide-block graft copolymer formed from a polyolefin backbone and at least one polyamide graft, in which:
the grafts are attached to the backbone via the residues of an unsaturated monomer (X) having a functional group capable of reacting with an amine-terminated polyamide; and
the residues of the unsatured monomer (X) are attached to the backbone by grafting or copolymerization from its double bond.

As regards the polyamide-block graft copolymer, this may be obtained by the reaction of an amine-terminated polyamide with the residues of an unsaturated monomer X attached by grafting or copolymerization to a polyolefin backbone.

This monomer X may, for example, be an unsaturated epoxide or an unsaturated carboxylic acid anhydride. The unsaturated carboxylic acid anhydride may be chosen, for example, from maleic, itaconic, citraconic, allylsuccinic, cyclohex-4-ene-1,2-dicarboxylic, 4-methylenecyclohex-4-ene-1,2-dicarboxylic, bicyclo[2.2.1]hept-5-ene-2,3-dicarboxylic and x-methylbicyclo[2.2.1]hept-5-ene-2,3-dicarboxylic anhydrides. Advantageously, maleic anhydride is used. It would not be outside the scope of the invention to replace all or part of the anhydride with an unsaturated carboxylic acid, such as for example acrylic acid or methacrylic acid. Examples of unsaturated epoxides were mentioned above.

As regards the polyolefin backbone, a polyolefin is defined as being a homopolymer or copolymer of alpha-olefins or diolefins, such as for example ethylene, propylene, 1-butene, 1-octene and butadiene.

As regards ethylene/X copolymers, that is to say those in which X is not grafted, they are copolymers of ethylene, X and optionally another monomer.

Advantageously, ethylene/maleic anhydride and ethylene/alkyl (meth)acrylate/maleic anhydride copolymers are used. These copolymers comprise from 0.2 to 10% by weight of maleic anhydride and from 0 to 40%, preferably 5 to 40%, by weight of alkyl (meth)acrylate. Their MFIs are between 5 and 100 (190° C./2.16 kg). The alkyl (meth)acrylates have already been mentioned above. The melting point is between 60 and 100° C.

With regard to the amine-terminated polyamide, the term “polyamide” is understood to mean the products resulting from the condensation:
of one or more amino acids, such as aminocaproic, 7-aminoheptanoic, 11-ainoundecanoic and 12-aminododecanoic acids or of one or more lactams, such as caprolactam, oenantholactam and lauryllactam;
of one or more salts or mixtures of diamines such as hexamethylenediamine, dodecamethylenediamine, metaxylylenediamine, bis(p-aminocyclohexyl)methane and trimethylhexamethylenediamine with diacids such as isophthalic, terephthalic, adipic, azeleic, suberic, sebacic and dodecanedicarboxylic acids;
or of mixtures of several monomers, resulting in copolyamides.

Polyamide or copolyamide blends may be used. Advantageously, PA-6, PA-11, PA-12, the copolyamide having 6 units and 11 units (PA-6/11), the copolyamide having 6 units and 12 units (PA-6/12) and the copolyamide based on caprolactam, hexamethylenediamine and adipic acid (PA-6/6,6) are used. The advantage of copolyamides is that it is thus possible to choose the melting point of the grafts.

Advantageously, the grafts are homopolymers consisting of residues of caprolactam, 1-amino-undecanoic acid or dodecalactam, or copolyamides consisting of residues chosen from at least two of the three above monomers.

The degree of polymerization may vary widely; depending on its value, this is a polyamide or a polyamide oligomer. In the rest of the text, the two expressions for the grafts will be used without distinction.

In order for the polyamide to have a monoamine terminal group, all that is required is to use a chain stopper of formula: 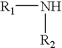
in which:
R₁ is hydrogen or a linear or branched alkyl group containing up to 20 carbon atoms;
R₂ is a linear or branched, alkyl or alkenyl, group having up to 20 carbon atoms, a saturated or unsaturated cycloaliphatic radical, an aromatic radical or a combination of the above. The chain stopper may, for example, be laurylamine or oleylamine.

Advantageously, the amine-terminated polyamide has a molar mass of between 1 000 and 5 000 g/inol and preferably between 2 000 and 4 000 g/mol.

The preferred amino acid or lactam monomers for synthesizing the monoaminated oligomer according to the invention are chosen from caprolactam, 11-amino-undecanoic acid or dodecalactam. The preferred monofunctional polymerization stoppers are laurylamine and oleylamine.

The polycondensation defined above is carried out using standard known processes, for example at a temperature generally between 200 and 300° C., in a vacuum or in an inert atmosphere, with stirring of the reaction mixture. The average chain length of the oligomer is determined by the initial molar ratio of the polycondensable monomer or the lactam to the monofunctional polymerization stopper. To calculate the mean chain length, it is usual practice to count one chain limiter molecule per oligomer chain.

The addition of the monoaminated polyamide oligomer to the polyolefin backbone containing X is effected by an amine functional group of the oligomer reacting with X. Advantageously, X carries an anhydride or acid functional group; amide or imide links are thus created.

The amine-terminated oligomer is added to the polyolefin backbone containing X preferably in the melt state. Thus, it is possible, in an extruder, to mix the oligomer with the backbone at a temperature generally between 230° and 250° C. The mean residence time of the melt in the extruder may be between 15 seconds and 5 minutes, preferably between 1 and 3 minutes. The efficiency of this addition is evaluated by selective extraction of the free polyamide oligomers, that is to say those that have not reacted to form the final graft copolymer having polyamide blocks.

The preparation of such amine-terminated polyamides and their addition to a polyolefin backbone containing X is described in U.S. Pat. No. 3,976,720, U.S. Pat. No. 3,963,799, U.S. Pat. No. 5,342,886 and FR 2291225.

As regards the triblocks g), mention may be made of S-B-M triblocks in which:
each block is linked to another by means of a covalent bond or an intermediate molecule linked to one of the blocks via a covalent bond and to the other block via another covalent bond;
the block M is formed from MMA monomers that are optionally copolymerized with other monomers and comprises at least 50% methyl methacrylate (MMA) by weight;
the block B is incompatible with the EVOH and with the block M; and
the block S is incompatible with the block B and the block M, and its T_{g} or its melting point Tₘ, is above the T_{g} of B.

As regards the S-B-M triblock, M is formed from methyl methacrylate monomers or contains at least 50 wt % methyl methacrylate, preferably at least 75 wt % methyl methacrylate. The other monomers making up the block M may or may not be acrylic monomers and may or may not be reactive. As non-limiting examples of reactive functional groups mention may be made of the following: oxirane functional groups, amine functional groups and carboxyl functional groups. The reactive monomer may be (meth)acrylic acid or any other hydrolysable monomer leading to these acids.

Among the other monomers that can form the block M, mention may be made, by way of non-limiting example, of glycidyl methacrylate and tert-butyl methacrylate. Advantageously, M is formed from at least 60% syndiotactic PMMA.

Advantageously, the T_{g} of B is below 0° C. and preferably below −40° C.

The monomer used to synthesize the elastomeric block B may be a diene selected from butadiene, isoprene, 2,3-dimethyl-1,3-butadiene, 1,3-pentadiene and 2-phenyl-1,3-butadiene. Advantageously, B is selected from poly(dienes), especially poly(butadiene), poly(isoprene) and random copolymers thereof, or else from partially or completely hydrogenated poly(dienes). Among polybutadienes, it is advantageous to use those whose T_{g} is the lowest, for example 1,4-polybutadiene having a T_{g} (about ° C.) below that of 1,2-polybutadiene (about 0° C.). The blocks B may also be hydrogenated. This hydrogenation is carried out using standard techniques.

The monomer used to synthesize the elastomeric block B may also be an alkyl (meth)acrylate; the following T_{g}s, given in brackets, which follow the name of the (meth)acrylate are obtained: ethyl acrylate (−24° C.), butyl acrylate (−54° C.), 2-ethylhexyl acrylate (−85° C.), hydroxyethyl acrylate (−15° C.) and 2-ethyhexyl methacrylate (−10° C.). It is advantageous to use butyl acrylate. The acrylates are different from those of the block M in order to meet the condition of B and M being incompatible.

Preferably, the blocks B are formed mostly from 1,4-polybutadiene.

The T_{g} or Tₘ of S is advantageously above 23° C. and preferably above 50° C. As examples of blocks S, mention may be made of those that derive from vinyl aromatic compounds such as, for example, styrene, α-methylstyrene and vinyltoluene.

Advantageously, the S-B-M triblock is a polystyrene/polybutadiene/PMMA triblock.

The S-B-M triblock has a number-average molar mass that may be between 10 000 g/mol and 500 000 g/mol, preferably between 20 000 and 200 000 g/mol. The S-B-M triblock advantageously has the following composition, expressed as fractions by weight, the total being 100%:
M: between 10 and 80% and preferably between 15 and 70%;
B: between 2 and 80% and preferably between 5 and 70%;
S: between 10 and 88% and preferably between 15 and 85%.

The S-B-M triblocks may be blended with S-B diblocks. As regards the S-B diblock, the blocks S and B have the same properties as the blocks S and B of the S-B-M triblock, they are incompatible and they are formed from the same monomers and optionally comonomers as the blocks S and the blocks B of the S-B-M triblock. That is to say, the blocks S of the S-B diblock are formed from monomers selected from the same family as the family of monomers available for the blocks S of the S-B-M triblock. Likewise, the blocks B of the S-B diblock are formed from monomers selected from the same family as the family of monomers available for the blocks B of the S-B-M triblock.

The S-B diblock has a number-average molar mass that may be between 10 000 g/mol and 500 000 g/mol, preferably between 20 000 and 200 000 g/mol. Advantageously, the S-B diblock is formed from a mass fraction of B of between 5 and 95% and preferably between 15 and 85%.

The blend of S-B-M triblock and S-B diblock advantageously comprises between 5 and 80% S-B diblock per 95 to 20% S-B-M triblock, respectively.

In addition, the advantage of these compositions is that it is unnecessary to purify the S-B-M after it has been synthesized. This is because S-B-M triblocks are generally prepared from S-B diblocks and the reaction often results in an S-B/S-B-M blend that is then separated in order to have the S-B-M triblock.

These S-B-M triblock copolymers may be manufactured by anionic polymerization, for example using the processes described in Patent Applications EP 524 054 and EP 749 987. They may also be manufactured by controlled radical polymerization. These S-B-M triblock copolymers are described in Patent WO 29772.

As Regards i)

S-B-S triblocks are described in Ullman's Encyclopedia of Industrial Chemistry, Volume A 26, pages 655-659.

As examples of S-B-S triblocks, mention may be made of linear triblocks in which each block is linked to another by means of a covalent bond or an intermediate molecule linked to one of the blocks via a covalent bond and to the other block via another covalent bond. The blocks S and B have the same properties as the blocks S and B of the S-B-M triblock, they are incompatible and they are formed from the same monomers and optionally comonomers as the blocks S and the blocks B of the S-B-M triblock. That is to say the blocks S of the S-B-S triblock are formed from monomers selected from the same family as the family of monomers available for the blocks S of the S-B-M triblock. Likewise, the blocks B of the S-B-S triblock are formed from monomers selected from the same family as the family of monomers available for the blocks B of the S-B-M triblock. The blocks S and B may be identical to or different from the other blocks S and B present in the other block copolymers.

The linear S-B-S triblock has a number-average molar mass that may be between 10 000 g/mol and 500 000 g/mol, preferably between 20 000 and 200 000 g/mol. The S-B-S triblock is advantageously formed from a mass fraction of B of between 5 and 95% and preferably between 15 and 85%.

As an other example of S-B-S triblocks, mention may be made of star triblocks. The term “triblock” does not accord with the number of blocks, but the term “S-B-S star triblock” is clear to those skilled in the art. As examples of star triblocks, mention may be made of those of formula: 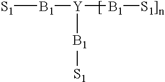
in which n is equal to 1, 2 or 3 and S₁ and B₁ represent blocks. The blocks SI represent polymerized styrene and the blocks B₁ polymerized butadiene, polymerized isoprene or a blend of polymerized butadiene and polymerized isoprene. The blocks B₁ may be hydrogenated (the triblocks are then, for example, S-EB-S triblocks).

Y is a polyfunctional entity coming, for example, from polyfunctional coupling agents that are used in the manufacture of star block copolymers. Such agents and these block copolymers are described in U.S. Pat. No. 3,639,521.

Preferred star block copolymers contain 15 to 45% by weight and better still 25 to 35% styrene units. The molar mass is at least 140 000 and better still at least 160 000.

Particularly preferred star block polymers are those described in EP 451 920. These copolymers are based on styrene and isoprene, the molar mass of the polystyrene blocks is at least 12 000 and the polystyrene content is at most 35% (by weight) of the total mass of the block copolymer.

The preferred linear block copolymers have a molar mass between 70 000 and 145 000 and contain 12 to 35% polystyrene by weight. Particularly preferred linear block copolymers are those based on styrene and isoprene that are described in European Patent EP 451 919. These copolymers have polystyrene blocks of molar mass between 14 000 and 16 000 and a polystyrene content of between 25 and 35% by weight of the block copolymer. The molar mass is between 80 000 and 145 000 and better still between 100 000 and 145 000.

It is also possible to use a blend of linear S-B-S triblocks and star S-B-S triblocks.

These linear or star S-B-S triblocks are commercially available under the brand names FINAPRENE®, FINACLEAR®, KRATON® and STYROLUX®.

1. Multilayer structure comprising the following successive layers:
a polyamide or HDPE (high-density polyethylene) layer;
a tie layer;
an impact-modified EVOH layer;
optionally, a tie layer; and
a polyamide or polyamide/polyolefin blend or polyolefin layer, the latter layer possibly containing fillers in order to make it antistatic;
and such that the impact-modified EVOH layer is a blend based on EVOH and at least one impact modifier selected from the group consisting of:
a) functionalized ethylene/alkyl (meth)acrylate copolymers;
b) products resulting from the reaction of (i) a copolymer of ethylene and of an unsaturated monomer X grafted or copolymerized with (ii) a polyamide;
c) blends of a) and b);
d) polyamides, preferably PA-6;
e) blends of a) and d);
f) elastomers, preferably EPR, EPDM and NBR, these elastomers possibly being functionalized;
g) S-B-M triblocks;
h) triblocks formed from a poly(butyl acrylate) block between two PMMA blocks; and
i) linear or star S-B-S block copolymers, these optionally being hydrogenated (they are then denoted by S-EB-S).

2. Structure according to claim 1, in which the proportion of impact modifier is:
by weight, between 1 and 35% per 99 to 65% of EVOH respectively.

3. Structure according to claim 1 in which the layer (1) is in direct contact with the fluid contained or transported.

4. Structure according to claim 1 in which the layer (1) is not antistatic and a layer (2) is attached to the structure on the layer (1) side, this layer (2) containing fillers in order to make it antistatic.

5. Structure according to claim 4 in which layer (2) is made of polyamide or polyamide/polyolefin blend or polyolefin.

6. Structure according to claim 4 in which a tie layer is inserted between layer (1) and layer (2).

7. Structure according to claim 4 in which the layer (2) is in direct contact with the fluid contained or transported.

8. A device for transferring or storing fluids consisting of the structure according to claim 1.

9. The device of claim 8 comprising a tube, a tank, a chute, a bottle or a container.
